(19) United States
(12) Patent Application Publication
(10) Pub. No.: US 2003/0228054 A1
(43) Pub. Date: Dec. 11, 2003

(54) Neurodynamic model of the processing of visual information

(75) Inventor: Gustavo Deco, Vilassar de Mar (ES)

Correspondence Address: STAAS & HALSEY LLP, SUITE 700, 1201 NEW YORK AVENUE, N.W., WASHINGTON, DC, 20005, US

(73) Assignee: Siemens Aktiengesellshaft, Munich (DE)

(21) Appl. No.: 10/425,994

(22) Filed: Apr. 30, 2003

(30) Foreign Application Priority Data
Apr. 30, 2002 (DE) 102 19 403.3

(51) Int. Cl. G06K 9/00; G06K 9/62

(52) U.S. Cl. 382/156; 382/181

(57) ABSTRACT

The model is a third generation neurosimulator. It has a plurality of areas whose functions can be identified with the functions of the areas of the dorsal and ventral path of the visual cortex of the human brain. Feedback is provided between different areas during processing. There is additionally provided competition for attention between different features and/or different spatial regions. The model is very flexibly suitable for image processing. It simulates natural human image processing and explains many experimentally observed phenomena.

### CROSS REFERENCE TO RELATED APPLICATIONS

This application is based on and hereby claims priority to German Application No. 102 19 403.3 filed on Apr. 30, 2002, the contents of which are hereby incorporated by reference.

### BACKGROUND OF THE INVENTION

Image processing primarily means object recognition and visual search for predefined patterns.

In known models of image processing, such as digital image processing, a recorded image is analyzed at successively higher processing levels. For searching for a feature in an image, e.g. the Eiffel Tower in Paris, in known image processing a distinction would be drawn between two questions:

The first question is: What object can be seen e.g. in the middle of the picture? In other words a “what” question asking for an object to be identified at the specified location (object recognition).

The second question is: Where is the Eiffel Tower? This is a “where” question seeking the location of the known feature in the picture (template search). For this purpose, the recorded image would typically be scanned with a specified suitable window corresponding to the pattern sought.

### SUMMARY OF THE INVENTION

One possible object of the invention is to improve object recognition and visual search for predefined patterns in the processing of recorded images.

Functional magnetic resonance imaging (fMRI) experiments (Kastner, S., De Weerd, P., Desimone, R., and Ungerleider, L. (1998). “Mechanism of directed attention in the human extrastriate cortex as revealed by functional MRI”. Science, 282,108-111; Wojciulik, E., Kanwisher, N., and Driver, J. (1998). “Covert visual attention modulates face-specific activity in the human fusiform gyrus: fMRI study”. Journal of Neurophysiology, 79, 1574-1578) and observation of the activities of individual cells in the brain (Moran, J. and Desimone, R. (1985). “Selective attention gates visual processing in the extrastriate cortex”. Science, 229, 782-784; Spitzer, H., Desimone, R. and Moran, J. (1988). “Increased attention enhances both behavioral and neuronal performance”. Science, 240, 338-340; Sato, T. (1989). “Interactions of visual stimuli in the receptive fields of inferior temporal neurons in awake macaques”. Experimental Brain Research, 77, 23-30; Motter, B. (1993). “Focal attention produces spatially selective processing in visual cortical areas V1, V2 and V4 in the presence of competing stimuli”. Journal of Neurophysiology, 70,909-919; Miller, E., Gochin, P. and Gross, C. (1993). “Suppression of visual responses of neurons in inferior temporal cortex of the awake macaque by addition of a second stimulus”. Brain Research, 616, 25-29; Chelazzi, L., Miller, E., Duncan, J. and Desimone, R. (1993). “A neural basis for visual search in inferior temporal cortex”. Nature (London), 363, 345-347; Reynolds, J., Chelazzi, L. and Desimone, R. (1999). “Competitive mechanisms subserve attention in macaque areas V2 and V4”. Journal of Neuroscience, 19, 1736-1753} have produced clear indications that attention influences the processing of visual information in that the activity of the neurons representing the anticipated feature (shape, color, etc.) or the anticipated location is increased, whereas the activity of adjacent neurons which would otherwise exert an inhibiting effect on the active neurons is reduced.

In known models of image processing, such as digital image processing, attention is irrelevant. Rather, a recorded image is analyzed at successively higher processing levels as part of a bottom-up approach.

In contrast to these known image processing models, it has been demonstrated that a so-called top-down approach better reflects the realities of the visual cortex. With a top-down approach, intermediate results at a higher processing level are used as feedback for meaningfully re-evaluating lower processing levels. The important element is the fact of feedback between the individual levels.

The model is structured in a plurality of areas whose functions can be identified with the functions of the areas of the dorsal and ventral path of the visual cortex. In the model to be specifically described below, feedback is implemented by the interaction of individual areas.

The feedback results in a shifting of the balance in the attention competition of the individual neurons or groups of neurons (pools, see below). This produces increasingly uneven competition for attention, causing the relevant features or spatial regions of the image to emerge in the course of image processing; after some time, these stand out from the other potential features.

Only increased attention for a specific spatial region or feature or object and accompanying neglect of the other features or spatial regions enables the data volume of an image to be reduced and therefore individual objects to be selectively perceived.

During this process, the recorded image is not searched bit by bit using a window. Rather the entire image is always processed in parallel.

Advantageously, a third generation neurosimulator (neurocognition) is used for processing. The term ‘first generation neurosimulators’ is applied to models of networks of neurons on a more or less static basis, the classical neural networks. The term ‘second generation neurosimulators’ is applied to models of the dynamic behavior of neurons, particularly of the pulses generated by them. The term ‘third generation neurosimulators’ is applied exclusively to hierarchical models of the organization of neurons into pools and of the pools into areas, one pool containing thousands of neurons. On the one hand, this results in reduced neural network complexity. On the other, the structure of the neural network therefore corresponds to that of the brain.

A further reduction in complexity can be achieved if the activity of the pools is described by a mean field model which is more suitable for analyzing rapid changes than the precise calculation of the activity of the individual neurons.

The competition for attention is preferably dealt with out at pool level. The competition can then be mediated via at least one inhibitory pool which exercises an inhibiting effect on the activity of the pools.

It is useful to organize the neural network in such a way that attention can be increased for a particular object to be identified or for a particular object to be located. Such increased attention or a balance shift (bias) in the competition for attention (“biased competition”) can be produced or amplified by signals originating from areas outside the visual cortex. These (external) signals can be coupled into the visual cortex where they stimulate particular features or spatial regions. They influence the competition for attention in that, with a large number of stimulating influences appearing in the field of vision, the competition for attention is won by the cells stimulated by the external signal, i.e. representing the anticipated feature or anticipated spatial region. Other cells lose attention and are suppressed (Duncan, J. and Humphreys, G. (1989). “Visual search and stimulus similarity”. Psychological Review, 96, 433-458; Desimone, R. and Duncan, J. (1995). “Neural mechanisms of selective visual attention”. Annual Review of Neuroscience, 18,193-222; Duncan, J. (1996). “Cooperating brain systems in selective perception and action”. In Attention and Performance XVI, T. Inue and J. L. McClelland (Eds.), pp. 549-578. Cambridge: MIT Press). An external bias of this kind can therefore determine whether object recognition (“what” question) or a template search (“where” question) is performed. Both processes can be carried out using the same method or model.

The object may be achieved by a computer program which, when it is run on a computer, performs the method according to the invention, and by a computer program with program code for carrying out all the steps according to the invention when the program is executed on a computer.

The inventor proposes a neurodynamic model of visual information processing which is capable of performing the method. For this purpose the model has a plurality of areas whose functions can be identified with the functions of the areas of the dorsal and ventral path of the visual cortex of the human brain. Feedback is provided between various areas during processing. In the model there is additionally provided competition for attention between different features and/or different spatial regions.

The object of the invention may also be achieved by implementing competition for attention between different features and/or different spatial regions of the visual information. In addition, a plurality of areas whose functions can be identified with the functions of the areas of the dorsal and ventral path of the visual cortex of the human brain, as well as means of implementing feedback between various areas during processing.

The inventor also proposes a computer program with program code for performing all the steps of the method when the program is executed on a computer.

The inventor further proposes a data medium on which a data structure is stored which, when loaded into the main memory of a computer, implements the method according to the invention.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows in simplified form the main areas of the visual cortex of the brain;

FIG. 2 shows an abstract representation of the areas of the brain and their synaptic connections; and

FIG. 3 schematically illustrates the interaction between an area and an associated inhibitory pool.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The purpose of the modeling is to provide a detailed neuronal network model of the areas of the brain which reflects the real conditions in the brain during activation processes, particularly in respect of visual attention control, and therefore allows these processes to be simulated for image processing.

A so-called third generation neurosimulator is used for modeling this top-down approach. The term ‘third generation neurosimulators’ is applied to hierarchical models of the organization of neurons into pools and of pools into areas corresponding to areas in the brain, as described below using the example of the visual cortex. One pool contains thousands of neurons.

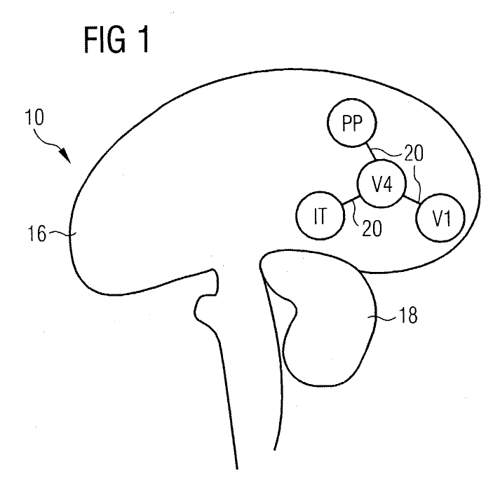

FIG. 1 shows in simplified form the main areas of the visual cortex of the brain 10. The cerebrum 16 and the cerebellum 18 are depicted. In the cerebrum 16, the visual cortex contains, among other things, the areas V1, V4, PP and IT illustrated. These are described in further detail below. Between these areas are multi-stranded synaptic connections 20.

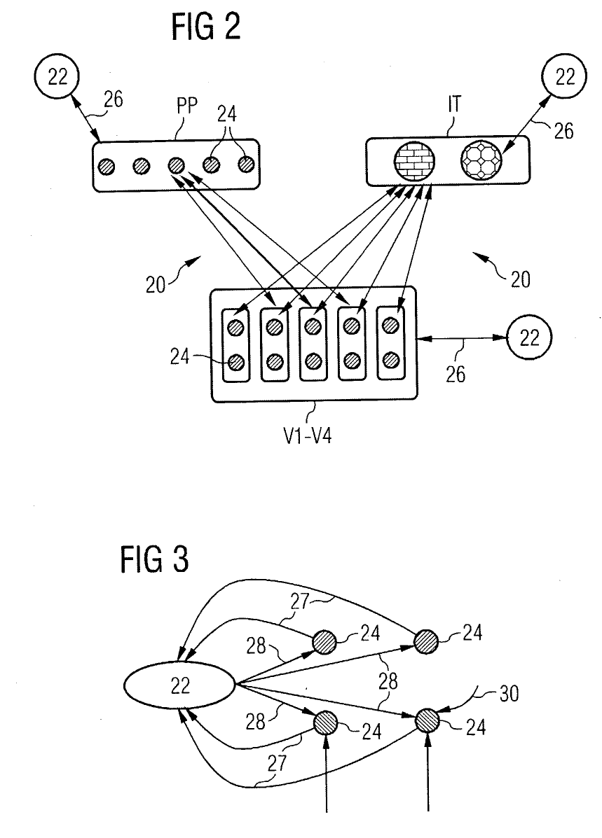

The structure of the mathematical model will now be described in detail with reference to FIG. 2 which represents the relationships in the brain in abstract form.

The area IT (inferotemporal) is used for image recognition or object recognition within an image (“what” question). Image patterns and stored therein which may correspond to representations of objects of the visible world. Two patterns, bricks and honeycomb, are shown by way of example. A pattern is recognized when a so-called “grandmother neuron” assigned to the pattern becomes maximally active. The ability of the “grandmother neuron” to recognize a particular pattern is acquired by training. This training is described below. Instead of using “grandmother neurons” for pattern recognition, this model employs the smallest unit of the model: the pool. A pattern is therefore recognized by a “grandmother pool” when the relevant grandmother pool is maximally active. Accordingly, in this model the area IT contains as many pools as there are patterns or objects to be recognized.

The area PP (posterior parietal) is used for locating known patterns (“where” question). In this model, the area PP therefore contains as many pools 24 as there are pixels in the image to be recognized. The concentration of neuronal activity in a small number of adjacent pools in PP corresponds to locating the object.

In general, the concentration of neuronal activity in one or more pools corresponds to increased attention for the features represented by these pools or identification of these features.

In this model, the areas V1 and V4 are combined into the area V1-V4 which is also designated as V4. This area is generally responsible for the extraction of features. It contains approximately 1 million pools 24, one pool for each feature. The pools 24 respond to individual features of the image. The features of the image are produced by wavelet transformation of the image (see below). A feature is therefore defined by a particular size or spatial frequency, a spatial orientation and a particular position in the x and y direction (see below). All the recorded image data is initially fed to the area V1-V4.

To each area is added at least one inhibitory pool 22, i.e. a pool which exerts an inhibiting effect on the activity of other pools. The inhibitory pools are linked to the excitatory pools by bidirectional connections 26. The inhibitory pools 22 bring about competitive interaction or competition for attention between the pools. The competition in V1-V4 is conducted by pools 24 which encode both location and object information. PP abstracts location information and mediates competition at the spatial level, i.e. template search. IT abstracts object category information and mediates competition at the object category level, i.e. object recognition.

Between the areas there are synaptic connections 20 by which the pools 24 can be stimulated to activity. The area IT is connected to the area V1-V4; the area PP is connected to V1-V4. The synaptic connections 20 simulated in the model between the areas reflect the “what” and “where” path of visual processing. The “what” path connects the area V1-V4 to the area IT for object recognition. The “where” path connects the area V1-V4 to the area PP for location. The areas IT and PP are not interconnected.

The synaptic connections 20 are always bidirectional, i.e. the data from V1-V4 is further processed in PP or IT. However, results from PP or IT are also simultaneously fed back to V1-V4 in order to control competition for attention.

The activities of the neuronal pools are modeled using the mean field approximation. Many regions of the brain organize groups of neurons with similar characteristics into columns or field groupings, such as orientation columns in the primary visual cortex and in the somatosensory cortex. These groups of neurons, known as pools, are composed of a large and homogeneous population of neurons which receive a similar external input, are interconnected and probably operate together as an entity. These pools can form a more robust processing and encoding unit than an individual neuron, because their instantaneous mean population response is more suitable for analyzing rapid changes in the real world than the temporal mean value of a relatively stochastic neuron in a predefined time window.

The activity of the neuronal pools is described using the mean field approximation, the pulse activity of a pool being expressed by an ensemble mean value x of the pulse rate of all the neurons in the pool. This mean activity x of the pool results from the stimulation of the neurons in the pool by the input pulse current I generally expressed in the form:

x(t)=F(I(t)), (1)

where F is a real function. For pulsed neurons of the integrate-and-fire type, which respond deterministically to the input current I, the following adiabatic approximation applies (Usher, M. and Niebur, E.: “Modelling the temporal dynamics of IT neurons in visual search: A mechanism of top-down selective attention”, Journal of Cognitive Neuroscience, 1996, pp. 311-327):

$$F ( I ( t ) ) = \frac{1}{{T}_{refractory} - τ log ( 1 - \frac{1}{τ I ( t )} )} , \qquad ( 2 )$$

where T_{refractory} is the dead time of a neuron after transmission of a pulse (approx. 1 ms) and τ is the latency of the neuron's membrane, i.e. the time between and external input and complete polarization of the membrane (Usher, M. and Niebur, E.: “Modeling the temporal dynamics of IT neurons in visual search: A mechanism of top-down selective attention”, Journal of Cognitive Neuroscience, 1996, pp. 311-327). A typical value for τ is 7 ms.

In addition to the mean activity x, the activity of an isolated pool of neurons can also be characterized by the strength of the input current I flowing between the neurons. This can be expressed as a function of time by the following equation:

$$τ \frac{\partial }{\partial t} I ( t ) = - I ( t ) + \tilde{q} F ( I ( t ) ) , \qquad ( 3 )$$

where the first term on the right-hand side describes the decay of activity and the second term on the right-hand side describes the mutual excitation between the neurons within the pool, i.e. the cooperative, excitatory interaction within the pool. \tilde{q} parameterises the strength of said mutual excitation. Typical values for \tilde{q} are between 0.8 and 0.95.

It shall be assumed that the directly recorded images are encoded in a gray-scale image which is described by an n×n matrix Γᵢⱼ^{orig}. A non-quadratic matrix is likewise possible. However, a 64×64 matrix is normally used, i.e. n=64, the subscripts i and j designating the spatial position of the pixel. The gray-scale value Γᵢⱼ^{orig} within each pixel is preferably encoded with 8 bits, bit value 0 corresponding the color black and bit value 255 to the color white. In general, color images of a higher dynamic can also be processed.

In the first processing step the constant portion of the image is subtracted. In the brain, this presumably occurs in the LGN (lateral geniculate nucleus) of the thalamus. By subtracting the mean value, we obtain the n×n image matrix Γᵢⱼ^{orig}:

$${Γ}_{ij} = {Γ}_{ij}^{orig} - \frac{1}{{n}^{2}} {\sum }_{i = 1}^{n} {\sum }_{j = 1}^{n} {Γ}_{ij}^{orig} . \qquad ( 4 )$$

The way in which features are extracted from the image by the pools in the area V-V4 according to the model is that the pools perform a Gabor wavelet transformation of the image, more precisely that the activity of the pools corresponds to the coefficients of a Gabor wavelet transformation.

The functions G_{kpql} used for the Gabor wavelet transformation are functions of the location x and y or of the discrete subscripts i and j and are defined by

G_{kpql}(x,y)=a^{-k}Ψ_{θ}_{ₜ}(a^{-k}x−pb,a^{-k}y−qb), (5)

where b is mainly selected as 1. Moreover

Ψ_{θ}_{ᵢ}(u,v)=ψ(u cos(lθ₀)+v sin(lθ₀),−u sin(lθ₀)+v cos(lθ₀)). (6)

The basic wavelet ψ(x,y) is defined by the product of an elliptical Gaussian function and a complex flat wave:

$$ψ ( r , s ) = \frac{1}{\sqrt{2 π}} {ⅇ}^{- \frac{1}{8} ( 4 {r}^{2} + {s}^{2} )} \cdot [ {ⅇ}^{ⅈ κr} - {ⅇ}^{- \frac{{κ}^{2}}{2}} ] . \qquad ( 7 )$$

K=π is preferably selected.

The Gabor wavelet functions therefore possess four degrees of freedom: k, l, p and q.

k corresponds to the size of the feature, expressed by the octave k, i.e. the spatial frequency, determined by the a\hat{ }kth of the fundamental frequency which is scaled by the parameter a; the value 2 is generally selected for a. The three octaves k=1, 2 and 3 are preferably considered.

I corresponds to the angular orientation, expressed by θₗ=l·θ₀.θₗ is therefore a multiple of the angular increment θ₀=π/L, i.e. the orientation resolution. Values from 2 to 10, usually 8, are preferably selected for L.

p and q determine the spatial position of the mid-point m of the function in x and y direction, expressed by

m=(mₓ,m_{y})=(pba^{k},qba^{k}) (8)

The activity I_{kpql}^{V4} of a pool in the area V1-V4, which responds to the spatial frequency at the octave k, the spatial orientation with the subscript I and to a stimulus whose center is determined by p and q, is accordingly stimulated by I_{kpql}^{V4,E} with:

$${I}_{kpql}^{V4 , E} := \sqrt{{‖ ⟨ {G}_{kpql} , Γ ⟩ ‖}^{2}} := \sqrt{‖ {\sum }_{i = 1}^{n} {\sum }_{j = 1}^{n} {G}_{kpql} ( i , {j ( {Γ}_{ij} ‖}^{2}} . \qquad ( 9 )$$

According to the model, this corresponds precisely to the coefficients of the Gabor wavelet function. The I_{kpql}^{V4,E} are preferably normalized to a maximum saturation value of 0.025. The relevant behavior of the pools is specified by previous training (see below)

The neurodynamic equations which determine the changes in the image processing system or model over time will now be considered.

The activity I_{kpql}^{V4} of a pool in the area V1-V4 with characteristics which are described by the parameters k, p, q and l described above changes over time in continuation of the equation (3) due to the inhibitory and excitatory input currents according to

$$\begin{matrix}τ \frac{\partial }{\partial t} {I}_{kpql}^{V4} = - {I}_{kpql}^{V4} + \tilde{q} F ( {I}_{kpql}^{V4} ) - \tilde{b} F ( {I}_{k}^{V4 , I} ) + \\ {I}_{kpql}^{V4 , E} + {I}_{pq}^{V4 - PP} + {I}_{kpql}^{V4 - IT} + {I}_{0} + v .\end{matrix} \qquad ( 10 )$$

The first two terms on the right-hand side were explained above. They represent the natural decay of activity or the mutual excitation within the pool.

The third term on the right-hand side of the equation (10), bF(Iₖ^{V4,I}), describes the abovementioned inhibiting effect of the inhibitory pool 22 described in further detail below. The parameter \tilde{b} on the right-hand side of the equation (10) scales the strength of the inhibition. A typical value for \tilde{b} is 0.8.

The fourth term on the right-hand side of the equation (10), I_{kpql}^{V4,E}, describes the stimulation by the recorded image according to the Gabor wavelet transformation according to the equation (9).

The fifth term on the right-hand side of the equation (10), I_{kpql}^{V4-PP}, describes the attention control for a feature having the spatial position corresponding to p and q, i.e. emphasis on the “where” question, as explained in greater detail below.

The sixth term on the right-hand side of the equation (10), I_{kpql}^{V4-IT}, describes the attention control in V1-V4 for particular patterns from IT, i.e. emphasis on the “what” question, as explained in greater detail below.

The seventh term on the right-hand side of the equation (10), I₀, describes the diffuse spontaneous background input. A typical value for I₀ is 0.025. v stands for the stochastic noise of the activity. For the sake of simplicity, this is assumed to be of equal strength for all the pools. A typical value for v is zero, for a Gaussian distribution with a standard deviation between 0.01 and 0.02.

The third term on the right-hand side of the equation (10), bF(Iₖ^{V4,I}), describes, as mentioned above, the inhibiting effect of the inhibitory pool 22 associated with the area V1-V4. Now referring to FIG. 3, the pools 24 within an area are in competition with one another, which is mediated by an inhibitory pool 22 which receives the excitatory input 27 from all the excitatory pools 24 and passes uniform inhibiting feedback 28 to all the excitatory pools 24. This inhibiting feedback 28 acts more strongly on less active than on more active pools. This means that more strongly active pools prevail over less strongly active pools.

FIG. 3 additionally shows an external input current 30 (bias) which can excite one or more pools. The precise function of the bias 30 is described in more detail below in connection with the equation (15).

The activities Iₖ^{V4,I} within the inhibitory pool satisfy the equation

$$τ \frac{\partial }{\partial t} {I}_{k}^{V4 , I} ( t ) = - {I}_{k}^{V4 , I} ( t ) + \tilde{c} {\sum }_{pql }^{} F ( {I}_{kpql}^{V4} ( t ) ) - dF ( {I}_{k}^{V4 , I} ( t ) ) . \qquad ( 11 )$$

The first term on the right-hand side of the equation (11) in turn describes the decay of the inhibitory pool 22. The second term describes the input current from V1-V4 to the inhibitory pool 22 associated with V1-V4 and having the subscript k, scaled by the parameter c. A typical value for \tilde{c} is 0.1.

The third term represents mutual inhibition of the inhibitory pool 22 associated with V1-V4 with the subscript k. A typical value for d is 0.1.

Experience has shown that the inhibitory effect within V1-V4 acts solely within a spatial structure of a specified size, expressed by the octave k. Within the structure of size k, there arises competition between the locations p and q and the orientation I, mediated by the sum

$${\sum }_{pql }^{} F ( {I}_{kpql}^{V4} ( t ) ) .$$

Each subscript triplet (p, q, l) inhibits any other subscript triplet (p, q, l). Spatial structures of different size k, i.e. of different spatial frequencies k, do not affect each other, as the inhibitory effect in the equation (10), −bF(Iₖ^{V4,I}), only retroacts on k itself.

The effect of the inhibitory pool 22 may be qualitatively understood as follows: the more pools are active in the area V1-V4, the more active the inhibitory pool 22 will be. This means that the inhibitory feedback which the pools experience in the area V1-V4 also becomes stronger. Only the most active pools in the area V1-V4 will therefore survive the competition.

As mentioned above, the fifth term on the right-hand side of the equation (10), I_{pq}^{V4-PP}, describes attention control for a feature having the spatial position corresponding to p and q, i.e. emphasis on the “where” question. Attention is controlled by feeding back the activity of the pools with subscripts i and j close to the values p and q from the area PP into the area V1-V4 to all the pools having the subscripts p and q. This feedback is modeled by

$${I}_{pq}^{V4 - PP} = {\sum }_{i = 1}^{n} {\sum }_{j = 1}^{n} {W}_{pqij} F ( {I}_{ij}^{PP} ) \qquad ( 12 )$$

where the coefficients W_{pqij} for their part are determined from a Gaussian function:

$${W}_{pqij} = A {ⅇ}^{- \frac{{dist}^{2} ( ( p , q ) , ( i , j ) )}{2 {S}^{2}}} - B \qquad ( 13 )$$

with the coupling constant A (typical value 1.5), with the spatial scaling factor S which specifies the range of the spatial effect of a feature (typically S=2), and with the distance function dist(p, q, i, j) which calculates the distance between the location having the subscript i, j and the center of the Gabor wavelet function defined by the subscripts p, q. The Euclidean metric is preferably used here:

dist²((p,q),(i,j))=(p−i)²+(q−j)², (14)

In addition, there is a negative connection B to the environment resulting in an overemphasis of adjacent features and a devaluation of more distant features. A typical value for B is 0.1.

In the effect, the pools with the spatial position corresponding to p and q do not directly excite the pools in V1-V4, but only after performing a convolution with a Gaussian kernel. In other words: V-V4 and PP are connected with symmetrical, localized connections which are modeled by Gaussian weights.

The change over time of the activity Iᵢⱼ^{PP} of the pools in the area PP is given by

$$τ \frac{\partial }{\partial t} {I}_{ij}^{PP} = - {I}_{ij}^{PP} + \tilde{q} F ( {I}_{ij}^{PP} ) - \tilde{b} F ( {I}^{PP , l} ) + {I}_{ij}^{PP - V4} + {I}_{ij}^{PP , A} + {I}_{0} + v . \qquad ( 15 )$$

The first, second, sixth and seventh terms of the equation correspond to the equation (10), but for the area PP.

The third term on the right-hand side in turn describes the inhibitory effect of the common inhibitory pool I associated with the area PP. Its activity I^{PP,I} satisfies the equation

$$τ \frac{\partial }{\partial t} {I}^{PP , l} = - {I}^{PP , I} + \tilde{c} {\sum }_{i , j}^{} F ( {I}_{ij}^{PP} ) - dF ( {I}^{PP , I} ) . \qquad ( 16 )$$

The third term corresponds in its structure to the equation (11) already described. There is only one uniform inhibitory effect for the area PP.

The fourth term on the right-hand side of the equation (15) in turn describes the attention-controlling feedback from V1-V4 to PP and is given by

$${I}_{ij}^{PP - V4} = {\sum }_{k , p , q , l}^{} {w}_{pqij} F ( {I}_{kpql}^{V4} ) , \qquad ( 17 )$$

where w_{pqij} was defined above in connection with the equation (13). The synaptic connections 20 between V1-V4 and PP are therefore implemented symmetrically. V1-V4 therefore controls attention in PP in respect of particular locations (“where” question).

The fifth term Iᵢⱼ^{PP,A} on the right-hand side of the equation (15) is an external top-down bias directing attention to a particular location (i,j), resulting in “biased competition”. This is represented in FIG. 3 by the arrow 30. If the bias is preset, an object is anticipated at the preset location. This results in recognition (“what”) of an object at the anticipated location. The bias towards a particular location therefore results in the answering of the “what” question. A typical value for this external bias is 0.07 for the anticipated location and 0 for all other locations.

The sixth term on the right-hand side of the equation (10), I_{kpql}^{V4-IT}, describes—as mentioned above—attention control in V1-V4 for particular patterns from IT, i.e. emphasis on the “what” question. Attention is controlled by feeding back an activity I_{c}^{IT} of the pools standing for the pattern c from the area IT to associated pools in the area V1-V4. This feedback is modeled by

$${I}_{kpql}^{V4 - IT} = {\sum }_{c}^{} {w}_{ckpql} F ( {I}_{c}^{IT} ) . \qquad ( 18 )$$

The determination of the weights W_{ckpql} of the input currents from IT to V1-V4 and therefore of the pools associated with the pattern c in the area V1-V4 will be explained below.

I_{c}^{IT} is the activity of a pool standing for the pattern c in the area IT. The change in I_{c}^{IT} over time is given by the differential equation:

$$τ \frac{\partial }{\partial t} {I}_{c}^{IT} = - {I}_{c}^{IT} + \tilde{q} F ( {I}_{c}^{IT} ) - \tilde{b} F ( {I}^{IT , l} ) + {I}_{c}^{IT - V4} + {I}_{c}^{IT , A} + {I}_{0} + v . \qquad ( 19 )$$

The first, second, sixth and seventh terms of the equation correspond to the equations (10) and (15), but for the area IT.

The third term on the right-hand side of the equation (19), −bF(I^{IT,I}) ,in turn describes the inhibitory effect of the inhibitory pool 22 associated with the pattern c of the area IT. The activity I^{IT,I} of the inhibitory pool associated with the area IT satisfies the equation

$$τ \frac{\partial }{\partial t} {I}^{IT , l} = - {I}^{IT , l} + \tilde{c} {\sum }_{c}^{} F ( {I}_{c}^{IT} ) - dF ( {I}^{IT , l} ) . \qquad ( 20 )$$

This equation corresponds in its structure to the equations (11) and (16) already described. For the area IT there is only one inhibitory effect which causes competition for attention between the individual patterns c.

The fourth term on the right-hand side of the equation (19), I_{c}^{IT-V4},in turn describes the attention-controlling feedback from V1-V4 to IT and is given by

$${I}_{c}^{IT - V4} = {\sum }_{k , p , q , l}^{} {w}_{ckpql} F ( {I}_{kpql}^{V4} ) , \qquad ( 21 )$$

where w_{ckpql} have already occurred in the equation (18) and will be explained in more detail below. The synaptic connections 20 between V1-V4 and IT are therefore implemented symmetrically. V1-V4 thus controls attention in IT in respect of particular patterns (“what” question).

The fifth term on the right-hand side of the equation (19), I_{c}^{IT,A} is an external top-down bias directing attention to a particular pattern c. If the bias is preset, a particular pattern c or object c is anticipated. This results in a search for the location in which the anticipated object is located (“what”). The bias towards a particular object or pattern therefore results in the answering of the “where” question. A typical value for this external bias is 0.07 for the anticipated pattern and 0 for all other patterns.

The system of differential equations specified is highly parallel. It includes approximately 1.2 million coupled differential equations. These are solved numerically by iteration, preferably by discretisation using the Euler or Runge-Kutta method. 1 ms is preferably selected as the time increment, i.e. approximately T_{refractory} according to the equation (2).

The weights w_{ckpql} of the synaptic connections between V1-V4 and IT are provided by Hebbian training (Deco, G. and Obradovic, D.: “An Information-theoretic Approach to Neurocomputing”. Springer Verlag (1996)) using known objects. For this purpose, patterns c are presented to the neural network at randomly selected locations (i,j). Random selection of the location at which the pattern is presented ensures translation-invariant object recognition. During presentation of the pattern c at the location (i,j), the external biases I_{c}^{IT,A} and Iᵢⱼ^{PP,A} associated with c and (i,j) are activated.

The Gabor wavelet transformation values (see above) of the patterns c stored in IT can be used for the weights w_{ckpql}.

After presentation of a pattern c at a location (i,j) and input of the external biases, we wait for the dynamic development of the system of equations until convergence. The w_{ckpql} are then iterated by Hebbs' rule

w_{ckpql}→w_{ckpql}+ηF(I_{c}^{IT})F(I_{kpql}^{V4}), (22)

using the values of the variables after convergence. η is the so-called learning coefficient. Typical values for η are between about 0.01 and 1, preferably 0.1.

Iteration is repeated for the object or pattern c and the spatial arrangement (i,j) until the weights w_{ckpql} converge.

This process is repeated for all the objects or patterns and all the possible spatial arrangements. This often produces millions of presentations or iterations.

Using the neural net described has enabled experimental data (Kastner, S.; De Weerd, P.; Desimone, R. and Ungerleider, L.: “Mechanisms of directed attention in the human extrastriate cortex as revealed by functional MRI”; Science 282 (1998) 108-111. Kastner, S.; Pinsk, M.; De Weerd, P.; Desimone, R. and Ungerleider, L.: “Increased activity in human visual cortex during directed attention in the absence of visual stimulation”; Neuron 22 (1999) 751-761.) to be quantitatively understood. The dynamics of pool activity in V1-V4 with clear changes in the sub-second range is as apparent in the model as it is experimentally. The same applies to attention control by anticipation and the inhibitory effect of simultaneous or adjacent stimuli.

Moreover, the model has been found to be consistent with the measurements of the activity of individual cells in the visual cortex (Moran, J. and Desimone, R. (1985). “Selective attention gates visual processing in the extrastriate cortex”. Science, 229, 782-784; Spitzer, H., Desimone, R. and Moran, J. (1988). “Increased attention enhances both behavioral and neuronal performance”. Science, 240, 338-340; Sato, T. (1989). “Interactions of visual stimuli. in the receptive fields of inferior temporal neurons in awake macaques”. Experimental Brain Research, 77, 23-30; Motter, B. (1993). “Focal attention produces spatially selective processing in visual cortical areas V1, V2 and V4 in the presence of competing stimuli”. Journal of Neurophysiology, 70, 909-919; Miller, E., Gochin, P. and Gross, C. (1993). “Suppression of visual responses of neurons in inferior temporal cortex of the awake macaque by addition of a second stimulus” Brain Research, 616, 25-29; Chelazzi, L., Miller, E. Duncan, J. and Desimone, R. (1993). “A neural basis for visual search in inferior temporal cortex”. Nature (London), 363, 345-347; Reynolds, J., Chelazzi, L. and Desimone, R. (1999). “Competitive mechanisms subserve attention in macaque areas V2 and V4”. Journal of Neuroscience, 19, 1736-1753).

With the new top-down approach, the entire image is processed in parallel. The features sought emerge in the course of processing, i.e. they stand out after a while as e.g. the “grandmother pools” which have won the competition between the individual pools or features become active. The “what” and “where” questions are answered using one and the same model. Only the so-called input bias is changed, i.e. attention is shifted in the direction of “what” or “where”. Anticipation is produced by the bias.

Using the model described it is possible to analyze images in a manner which simulates human image processing during visualization.

The invention has been described in detail with particular reference to preferred embodiments thereof and examples, but it will be understood that variations and modifications can be effected within the spirit and scope of the invention.

What is claimed is:

1. A method for processing visual information, comprising:
implementing competition for attention between different features and/or different spatial regions of the visual information;
using a plurality of areas to process the visual information, the areas having respective functions which correspond with functions of the human brain at a dorsal and ventral path of the visual cortex; and
providing feedback between the areas during processing.

2. The method according to claim 1, wherein
each area is modeled as a neural network,
for each neural network, a plurality of neurons are combined into a pool, and
activity of the pools is simulated.

3. The method according to claim 2, wherein activity of the pools is described by a mean field model.

4. The method according to claim 2, wherein
the pools are in competition with one another for attention, and
competition between the pools is mediated by at least one inhibitory pool which exerts an inhibiting effect on the activity of the pools.

5. The method according to claim 2, wherein attention is increased for a particular object to be identified or object to be located.

6. The method according to claim 2, wherein
an identification area of the neural network identifies objects in a field of vision, and
each of the pools of the identification area is specialized for identifying a corresponding object.

7. The method according to claim 2, wherein
a location area of the neural network identifies a location of a recognizable object in a field of vision, and
the pools of the location area are specialized for locating a recognizable object at respective specific locations in the field of vision.

8. The method according to claim 3, wherein
the pools are in competition with one another for attention, and
competition between the pools is mediated by at least one inhibitory pool which exerts an inhibiting effect on the activity of the pools.

9. The method according to claim 8, wherein attention is increased for a particular object to be identified or object to be located.

10. The method according to claim 9, wherein
an identification area of the neural network identifies objects in a field of vision, and
each of the pools of the identification area is specialized for identifying a corresponding object.

11. The method according to claim 10, wherein
a location area of the neural network identifies a location of an object in a field of vision, which was recognized by the identification area, and
the pools of the location area are specialized for locating objects at respective specific locations in the field of vision.

12. A neurodynamic model to process visual information, comprising:
a plurality of areas to process the visual information, the areas having respective functions which correspond with functions of the human brain at a dorsal and ventral path of the visual cortex;
a feedback connection to provide feedback between areas during processing; and
a competition mechanism for the areas to compete for attention between different features and/or different spatial regions.

13. A system to process of visual information, comprising:
means of implementing a competitive weighting between different features and/or different spatial regions of visual information;
a plurality of areas to process the visual information, the areas having respective functions which correspond with functions of the human brain at a dorsal and ventral path of the visual cortex;
means for implementing feedback between the areas during processing; and
means for concluding that the feature and/or spatial region is associated with correct information if the feature and/or spatial region has the greatest weighting.

14. A computer readable medium storing a program for controlling a computer to perform a method for processing visual information, the method comprising:
implementing competition for attention between different features and/or different spatial regions of the visual information;
using a plurality of areas to process the visual information, the areas having respective functions which correspond with functions of the human brain at a dorsal and ventral path of the visual cortex; and
providing feedback between the areas during processing.
